(19) United States
(12) Patent Application Publication
(10) Pub. No.: US 2023/0257214 A1
(43) Pub. Date: Aug. 17, 2023

(54) SCREW SUPPLY JIG, TWO-ARMED ROBOT USING SAID SCREW SUPPLY JIG, AND SCREW SUPPLY METHOD

(71) Applicant: KAWASAKI JUKOGYO KABUSHIKI KAISHA, Kobe-shi, Hyogo (JP)

(72) Inventors: Kazunori HIRATA, Kobe-shi (JP); Keita SASAKI, Kobe-shi (JP)

(73) Assignee: KAWASAKI JUKOGYO KABUSHIKI KAISHA, Kobe-shi, Hyogo (JP)

(21) Appl. No.: 18/009,687

(22) PCT Filed: Jun. 4, 2021
(86) PCT No.: PCT/JP2021/021387

§ 371 Date: Dec. 9, 2022

(30) Foreign Application Priority Data
Jun. 9, 2020 (JP) 2020-099928

(51) Int. Cl. B65G 47/90

(52) U.S. Cl. CPC B65G 47/907; B65G 2201/02

(57) ABSTRACT

A screw supply jig includes first and second members, the second being disposed lower than the first. Either member can be slidably moved relative to the other. In the first member, a first passage hole is formed in the vertical direction. In the second member, at least a part of a second passage hole is formed in the vertical direction. The second passage hole has a first and second recessed part which is penetration shape and having a larger than the first recessed part in planar view. The recessed parts are disposed side by side in the direction of relative sliding of the members, and are connected to each other. In conjunction with the relative sliding, a situation in which the first recessed part of the second passage hole faces the first passage hole, and a situation in which the second recessed part faces the first passage hole are switched.

### TECHNICAL FIELD

The present invention relates mainly to the configuration of a screw supply jig for supplying a screw to a workpiece to be screwed.

### BACKGROUND ART

Conventionally, it is known that an automatic screw tightening device which automatically supplies a screw to a predetermined screwing target portion of an object and apply screw tightening. PTL 1 discloses this type of a screw tightening device.

The automatic screw tightening device in PTL 1 is configured to transfer screw via a transfer pipe of screw by an air suction.

### CITATION LIST

### Patent Literature

PTL 1: Japanese Patent No. 5513964

### SUMMARY OF INVENTION

### Technical Problem

However, with the configuration in PTL 1, the configuration of device becomes complicated because it is necessary to provide a device for generating an air suction force and a transport pipe.

Additionally, depending on the object, it may be necessary to tighten multiple size screws on one object. In this point, in PTL 1, it is necessary to provide a different thicknesses of transport pipe or adjust an air suction force in the respective moving tubes, according to the size of the screw. Therefore, according to a conventional configuration, for example, when tightening work is performed by using a different size screw, it was necessary to significantly change a device because of the lack of flexibility.

The present invention has been made in view of the circumstances described above, and an object of the present invention is to realize a supply screw with a simple and compact constitution that flexibly in various situations.

### Solution to Problem

Problems to be solved by the present invention are as described above. Solutions to the problems and advantageous effects thereof will now be described.

That is, a first aspect of the present invention provides a screw supply jig configuration as follows. That is, this screw supply jig is employed to supply screws to a workpiece to be screwed. The screw supply jig includes a first member and a second member. The second member is disposed lower the first member. Either of the first member and the second member can be slidably moved in a mutual relative to the other. In the first member, a first passage hole penetrating through the first member is formed in the vertical direction. in the second member, at least a part of a second passage hole penetrating through the second member is formed in the vertical direction. The second passage hole has a first recessed part and a second recessed part which is a penetration shape and having a larger than the first recessed part in planar view. The first recessed part and the second recessed part are disposed side by side in the direction of relative sliding of the first member and the second member, and are connected to each other. In conjunction with the relative sliding of the first member and the second member, a situation in which the first recessed part of the second passage hole faces the first passage hole, and a situation in which the second recessed part faces the first passage hole are switched each other.

A second aspect of the present invention provides a screw supply method as described below for supplying a screw to a workpiece to be screwed. That is, this screw supply method includes a positioning process and a screw supplying process. With the positioning process, a screw supply jig as described below is employed. This screw supply jig includes a first member and a second member disposed lower the first member. Either of the first member and the second member can be slidably moved in a mutual relative to the other. In the first member, a first passage hole penetrating through the first member being formed in the vertical direction, and in the second member, a second passage hole in which at least a part of the second member being formed in the vertical direction. The second passage hole has a first recessed part and the second recessed part, the second recessed part which is a penetration shape and having a width larger than the first recessed part in planar view. In the positioning process, the screw supply jig is held by using a screw supply device in the state of the first recessed part faces the first passage hole and a screw is disposed in the first recessed part and the first passage hole. With the positioning process, the screw supply jig held moves so that the screw may be moved directly above the supply target position on the workpiece to be screwed by the screw supply device. With the screw supplying process, the screw is naturally dropped by relatively sliding the first member and the second member slide portion so that the second recessed part faces the first passage hole.

As this result, for example, when tightening respective screws of different sizes from each other, a screw can be supplied flexibly in various situations. In addition, it is advantageous for cost reduction because of the simple structure.

### Effect of the Invention

According to the present invention, it is possible to realize a screw supply with a simple and compact constitution that flexibly in various situations.

### BRIEF DESCRIPTION OF DRAWINGS

FIG. 1 A perspective view showing the summarily configuration of an automatic assembling system according to an embodiment of the present invention.

FIG. 2 A perspective view showing an example of a screw supply jig.

FIG. 3 An exploded perspective view showing the configuration of an example of a screw supply jig.

FIG. 4 A first sectional perspective view showing the configuration of an example of a screw supply jig.

FIG. 5 A second sectional perspective view showing the configuration of an example of the screw supply jig.

### DESCRIPTION OF EMBODIMENTS

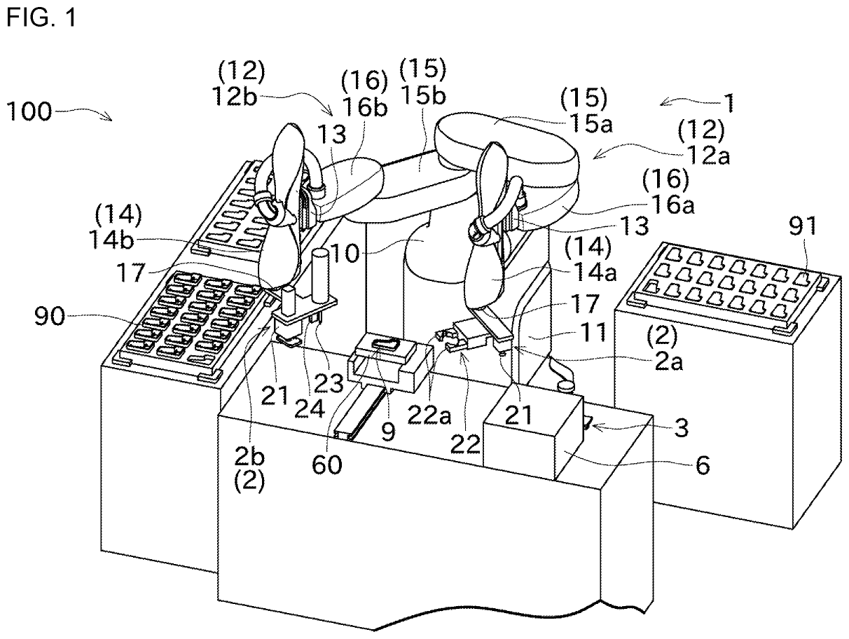

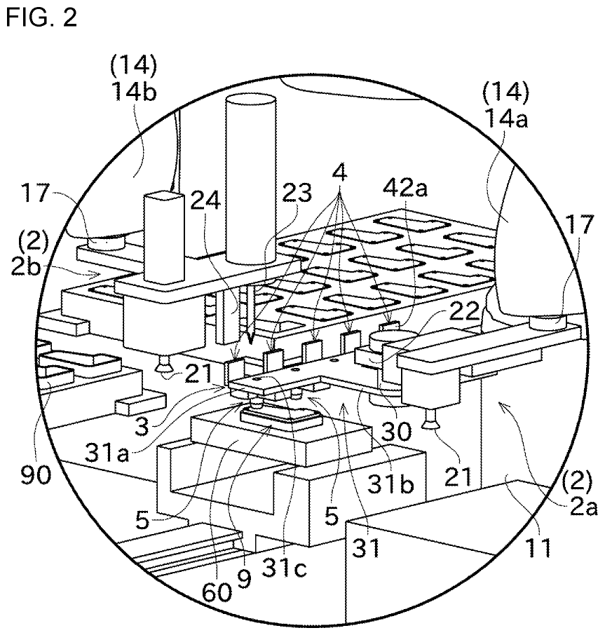

To begin with, an embodiment of the present invention will now be described with reference to the drawings. FIG. 1 is a perspective view showing a summarily configuration of an automatic assembling device 100 according to an embodiment of the present invention. FIG. 2 is a perspective view showing an example of the screw supply jig 3.

The automatic assembling device 100 shown in FIG. 1 is employed for assembling various products that require screw tightening. As described below, a work to be screwed is referred to as a workpiece to be screwed 9.

As an example of the product to be the workpiece to be screwed 9, an electric module as shown in FIG. 1 can be given. In the present embodiment, the electric module having a configuration in which an electronic board 91 is disposed in the inside of a case 90.

The automatic assembling device 100 is mainly configured of a dual-arm robot (screw supply device) 1. In the present embodiment, although a horizontal articulated dual-arm robot is employed as the dual-arm robot 1, a vertical articulated dual-arm robot may also be employed.

The dual-arm robot 1 includes a base 11, two arms 12, a wrist 13 provided at the tip of each arm 12, and an end wrist portion 14 provided on each wrist 13.

The base 11 can function as a base member for supporting the above-two arms mounted by the dual-arm robot 1, and a base member supporting two wrists 13 and the end wrist portion 14. Inside the base 11, for example, a robot controller (not shown) for controlling the operation of such as the arms 12 and the end wrist portion 14 is disposed.

In the following description, with respect to the arm 12, or the portion constituting the arm 12, an end portion closer to the base 11 is referred to as the “base portion”, and an end portion farther from the base 11 is referred to as the “tip portion”.

The two arms 12 mounted by the dual-arm robot 1 are the same configuration. In the present embodiment, the respective arms 12 includes a base arm 15 and a link arm 16. The base arm 15 is disposed on the base side of the arm 12, and the link arm 16 is disposed on the tip side, respectively. The base arm 15 and the link arm 16 are connected to each other.

As described below, each of the two arms 12 may be referred to as a first arm 12a and a second arm 12b. In addition, the base arm 15 and the link arm 16 mounted by the first arm 12a may be referred to as a first base arm 15a and a first link arm 16a, and the base arm 15 and the link arm 16 mounted by the second arm 12b may be referred to as a second base arm 15b and a second link arm 16b. Further, the end wrist portion 14 provided on the first arm 12a may be referred to as a first end wrist portion 14a, and the end wrist portion 14 provided on the second arm 12b may be referred to as a second end wrist portion 14b.

The respective base arms 15 is composed as an elongated member extending in a linear shape arranged in horizontal. A base shaft 10 is fixed on the upper face of the base 11. One end (base end) of the respective base arms 15 in the longitudinal direction is rotatably provided with respect to the base shaft 10. The base arm 15 rotates around the axis of the base shaft 10. The first base arm 15a and the second base arm 15b are disposed in the vertical direction by making a position different. Specifically, the first base arm 15a and the second base arm 15b are attached to the base shaft 10 in this order from the upside.

The respective link arms 16 is composed as an elongated member extending in a linear shape arranged in horizontal.

One end (base end) of the link arm 16 in the longitudinal direction is attached at the tip of the base arm 15. The link arm 16 is rotatably supported with the axis parallel to the base shaft 10 as the center. The wrist 13 is attached to the other end (tip) of the longitudinal direction of the link arm 16.

The first link arm 16a is connected to the first base arm 15a from the lower side of the first base arm 15a. The second link arm 16b is connected to the second base arm 15b from the upper side of the second base arm 15b. Consequently, it will be easy to offset the height difference occurring on the base end portions of the two base arms 15. In other words, by simple configuration, the two wrists 13 can be disposed at substantially the same height.

The wrist 13 is fixed at the tip of the link arm 16. Specifically, the wrist 13 is provided so as to project from the tip of the link arm 16 in the longitudinal direction. In the wrist 13, the end wrist portion 14 is attached so as to be slidable vertically.

The end wrist portion 14 can move up and down with respect to the wrist 13. The end wrist portion 14 is composed as an elongated member extending in the vertical direction. A rotating joint 17 is provided at the lower end of the end wrist portion 14.

The rotating joint 17 is supported on the end wrist portion 14. The rotating joint 17 can be rotated relative to the end wrist portion 14. An end effector 2 is installed to the rotating joint 17. As the end effector 2 attached to the respective arms 12, various end effectors 2 can be selected. By the rotating joint 17, the end effector 2 can be rotated with respect to the end wrist portion 14.

Appropriate actuators are disposed in each portion of the arm 12. The actuator is, for example, electric motor, and is controlled by the above-described robot controller. By these actuators, each portion of the arm 12 can be driven.

To continue: the two end effectors 2 attached to the dual-arm robot 1 of the present embodiment will be briefly described.

First, a first end effector 2a attached to the first end wrist portion 14a of the first arm 12a will be described. As shown in FIG. 1, the first end effector 2a mainly includes an adsorbing portion 21 and a member gripping portion 22.

The adsorbing portion 21 can generate negative pressure to adsorb a workpiece to be assembled such as the electronic board 91.

The member gripping portion 22 includes a pair of symmetrically disposed holding portions 22a. The pair of holding portions 22a can be slidably moved in the direction of approaching or leaving each other. In the respective gripping portions 22a, a semicircular recessed part is formed on a surface opposite to each other. These conditions, the member gripping portion 22 can be easily grasped a member having a round bar-shaped portion.

Next, a second end effector 2b attached to the second end wrist portion 14b of the second arm 12b will be described. As shown in FIG. 1, the second end effector 2b includes the adsorbing portion 21, an electric driver (screw tightening tool) 23, and a lever pressing portion (pressing portion) 24.

The adsorbing portion 21 has the same configuration as the adsorbing portion 21 of the first end effector 2a, and can adsorb the case 90 or the like.

An electric driver 23 is employed for screw tightening. The electric driver 23 includes a driver bit which can be plugged into the screw head. According to instructions, the electric driver 23 has a well-known function which can change the tightening torque.

A lever pressing portion 24 is composed as a small plate-type member. The lever pressing portion 24 is employed to press a slide portion 4 mounted by the screw supply jig 3, which will be described later.

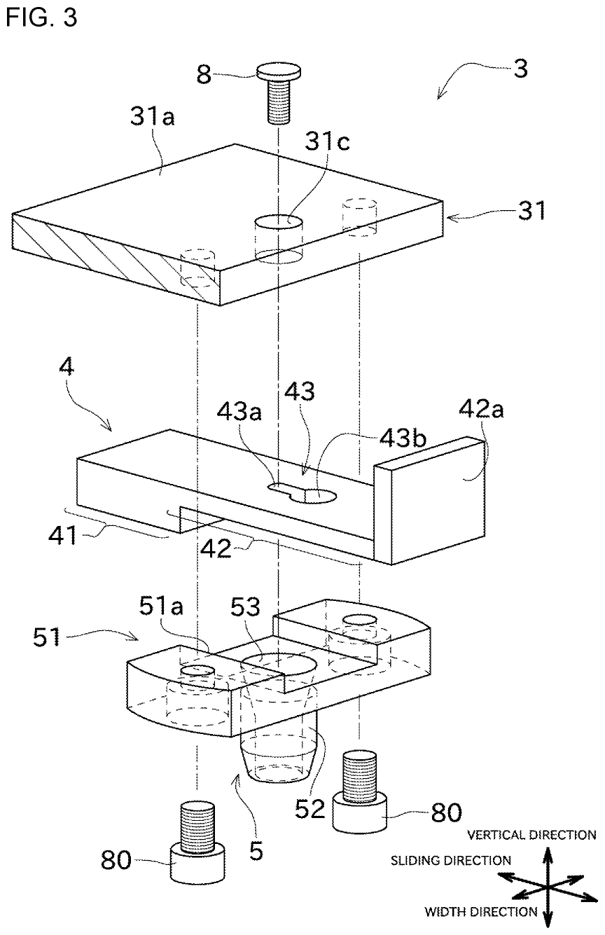

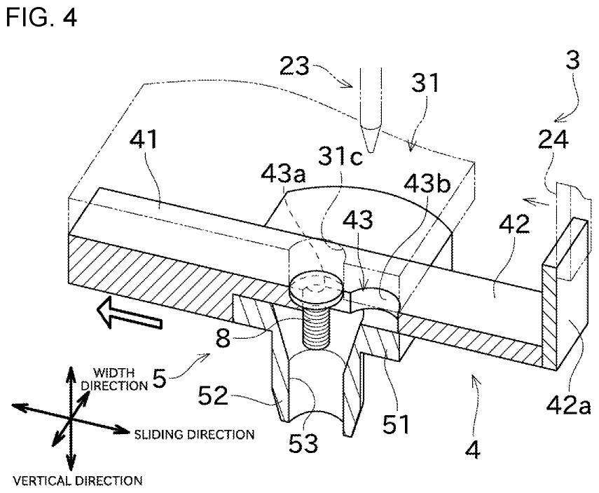

Next, the configuration of the screw supply jig 3 employed by the automatic assembling device 100 of the present embodiment will be described in detail with reference to FIG. 3 and the like. FIG. 3 is an exploded perspective view showing the configuration of an example of a screw supply jig 3. FIG. 4 is a sectional perspective view showing the configuration of an example of the screw supply jig 3.

Since the details will be described later, the screw supply jig 3 includes the slide portion 4 that slides in almost horizontal linear direction. Hereinafter, the direction in which the slide portion 4 slides relative to the screw supply jig 3 may be referred to as the sliding direction (first direction). Additionally, a direction perpendicular to both the sliding direction and the vertical direction may be referred to as the width direction (second direction) of the screw supply jig 3. The width direction of the screw supply jig 3 may also be called the width direction of the slide portion 4.

As shown in FIG. 2, the automatic assembling device 100 of the present embodiment can be easily grasped the screw supply jig 3 via the member gripping portion 22 of the first end effector 2a.

The screw supply jig 3 is composed to be able to supply a plurality of screws one by one. The screw supply jig 3 includes a gripped portion 30 formed cylindrically. The screw supply jig 3 is, via the gripped portion 30, gripped by the member gripping portion 22 of the first end effector 2a.

The screw supply jig 3 includes a base portion (first member) 31, a plurality of slide portions (second member) 4, and a plurality of screw guide portions 5.

The base portion 31 is formed in a plate shape. The base portion 31 is directed so as to be consistent with its thickness direction.

In a plan view, the base portion 31 is formed in a T-shaped as a whole in which two slender rectangular parts are connected to each other. In the following, these rectangular parts are referred to as a first rectangular part 31a and a second rectangular part 31b. In the middle part in the longitudinal direction of the first rectangular part 31a, one longitudinal end part of the second rectangular part 31b is connected. The longitudinal direction of the first rectangular part 31 is consistent with the width direction of the screw supply jig 3, and the longitudinal direction of the second rectangular part 31b is consistent with the sliding direction of the slide portion 4.

In the longitudinal direction of the second rectangular part 31b, the gripped portion is disposed on the end portion opposite to the side connected to the first rectangular part 31a. Gripping the gripped portion 30 with the first end effector 2a, the base portion 31 can be positioned with respect to the first end effector 2a.

The base portion 31 can move in conjunction with the first end effector 2a. When tightening a screw and supplying a screw 8, the first end effector 2a is controlled with the above-described robot controller as to stop them at an appropriate position with respect to the workpiece to be screwed 9.

The base portion 31 may have a shape differs, and if necessary, instead of the T-shaped, for example, an L-shaped or an I-shaped can also be configured.

Along the longitudinal direction of the first rectangular part 31a, a plurality of slide portions 4 and a plurality of screw guide portions 5 are provided side by side. The plurality of slide portions 4 are disposed at appropriate intervals along the longitudinal direction of the first rectangular part 31a. It is similar for the plurality of screw guide portions 5. The slide portion 4 and the screw guide portion 5 are provided in a one-to-one correspondence. For the number of slide portions 4 and the screw guide portions 5, it is preferable to determine in consideration the number of screws to be screwed.

In the first rectangular part 31a of the base portion 31, a holding hole (first passage hole) 31c is formed so as to correspond to the slide portion 4 and the screw guide portion 5, respectively. The respective holding holes 31c is formed so as to penetrate through the first rectangular part 31a in the thickness direction. The plurality of holding holes 31c are disposed at appropriate intervals along the longitudinal direction of the first rectangular part 31a.

As shown in FIG. 3, a holding hole 31c is a circular hole. The inner diameter of the holding hole 31c is slightly larger than the screw head 8 to be screwed. Therefore, in the case of the axis of the screw 8 is oriented so as to be consistent with the axis of the holding hole 31c, the screw 8 can pass through the holding hole 31c.

As shown in FIG. 3, the respective slide portions 4 is formed thin and long. The respective slide portions 4 is disposed adjacent to the lower face of the base portion 31 and supported with the screw guide portion 5. The slide portion 4 can reciprocate linearly with respect to the base portion 31 along the sliding direction showing in FIGS. 3 and 4. This sliding direction is perpendicular to the vertical direction and that is consistent with the longitudinal direction of the slide portion 4. It is possible to realize the relative sliding between the base portion 31 and the slide portion 4 by sliding the slide portion 4 with respect to the base portion 31. The sliding direction of the slide portion 4 is consistent with the relative sliding direction between the base portion 31 and the slide portion 4. Each of the plurality of slide portions 4 can performs independently the slide portion movement above-described of the others.

The slide portion 4, for example, is made of a metal member having rigidity. Unfortunately, it is not limited to this, and for example, the slide portion 4 may be made from other materials such as synthetic resin.

The slide portion 4 includes a stopper portion 41, a body portion 42, and a lever (pressed part) 42a. The stopper portion 41 and the body portion 42 are disposed in the above-described sliding direction.

The stopper portion 41 is formed in the shape of a rectangular plate. The stopper portion 41 is formed thicker than the body portion 42. And thus, the stopper portion 41 projects lower side than the body portion 42. This projecting part can be contacted with a screw guide portion 5, which will be described later. In the following, the position of the slide portion 4 when the stopper portion 41 is in contact with the screw guide portion 5 is referred to as a base position. This base position is located to one end of the reciprocating stroke of the slide portion 4.

The body portion 42 is formed in the shape of an elongated rectangular plate. The body portion 42 is located between the base portion 31 and the screw guide portion 5.

The body portion 42 is formed integrally with the stopper portion 41. The body portion 42 is extended away from the stopper portion 41 and is projected horizontally from lower side of the base portion 31. A small plate-type lever 42a is fixed on this projecting part. The lever 42a is disposed so as to rise from the tip of the body portion 42. By the lever 42a, the lever pressing portion 24 mounted by the second end effector 2b can be contacted. However, omitting the vertical plate-shaped lever 42a, and the configuration may be such that the lever pressing portion 24 directly contacts the tip of the body portion 42.

In the body portion 42, a switching hole (second passage hole) 43 is formed. The switching hole 43 penetrates the body portion 42 in the thickness direction (vertical direction) of the slide portion 4. The switching hole 43 is formed at a position corresponding to the holding hole 31c formed in the base portion 31. To be specific, when viewed in the vertical direction, at least a part of a portion of the switching hole 43 is superposed with the holding hole 31c.

The switching hole 43 is configured by connecting a long hole part (first recessed part) 43a and a round hole part (second recessed part) 43b. Both of the long hole part 43a and the round hole part 43b are formed so as to penetrate through the body portion 42 in the vertical direction. The long hole part 43a and the round hole part 43b are disposed side by side in the sliding direction of the slide portion 4, and their internal spaces are connected to each other.

The long hole part 43a is disposed so that its longitudinal direction is consistent with the sliding direction of the slide portion 4. In the longitudinal direction of the long hole part 43a, the end portion closer to the lever 42a is connected to the round hole part 43b. The width of the long hole part 43a is larger than the outer diameter of the screw 8 shaft to be screwed, and is smaller than the outer diameter of the screw head 8. Therefore, the long hole part 43a can pass through the screw shaft 8, but the long hole part 43a cannot pass through the screw head 8.

The round hole part 43b is a circular hole. The inner diameter of the round hole part 43b is, similarly to the holding hole 31c, slightly larger than the screw head 8 to be screwed. Consequently, the round hole part 43b can pass through both the screw shaft 8 and the screw head 8.

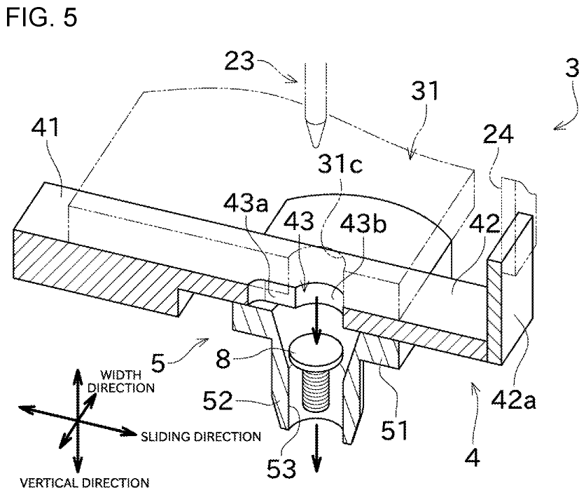

When the slide portion 4 is placed in the above-described base position, as shown in FIG. 4, the long hole part 43a among the switching hole 43 faces the holding hole 31c in the vertical direction. A state in which the slide portion 4 has moved in the direction shown by a white arrow of FIG. 4 is shown in FIG. 5. In the above state, the round hole part 43b of the switching hole 43 faces the holding hole 31c in the vertical direction.

In the slide portion 4, in which a return mechanism (not shown) is connected. For example, this return mechanism is composed of a spring. The return mechanism always applies a force in the direction opposite to the white arrow of FIG. 4. As this result, at the state of the non-application of a force to the lever 42a, the slide portion 4 is held at the base position as shown in FIG. 4.

The screw guide portion 5 is employed to guide the screw 8 which have passed through the base portion 31 and the slide portion 4 and dropped, to the screw tightening position (position to be supplied). Furthermore, the screw guide portion 5 has a function which supports the slide portion 4 and guides its sliding direction.

The screw guide portion 5 is disposed lower the base portion 31 and body portion 42. As shown in FIG. 3, the screw guide portion 5 includes a slide guide portion 51 and a chute portion 52.

The slide guide portion 51 is formed in the shape of an elongated plate. The slide guide portion 51 is directed so as to be consistent with its thickness direction. In a plan view, the longitudinal direction of the slide guide portion 51 is perpendicular to the longitudinal direction of the slide portion 4.

As shown in FIG. 3, both longitudinal ends of the slide guide portion 51 are fixed to the base portion 31 with a respective bolt 80. It should be understood that the bolt 80 is omitted in FIGS. 4 and 5.

A slide groove 51a whose upper side is opened is formed on the upper face of the slide guide portion 51 at the central portion in the longitudinal direction. The body portion 42 of the slide portion 4 is disposed inside the slide groove 51a. By the slide groove 51a, the sliding direction of the slide portion 4 is guided.

The chute portion 52 is a cylindrical portion. The chute portion 52 is formed integrally with the slide guide portion 51 so as to project from the lower face of the longitudinal central portion of the slide guide portion 51.

In the screw guide portion 5, a circular penetration hole 53 is formed. The penetration hole 53 is formed so as to penetrate the screw guide portion 5 in the vertical direction. The upper end of the penetration hole 53 being opened in the bottom face of the slide groove 51a, and the lower end of the penetration hole 53 being opened in the lower face of the chute portion 52.

The inner diameter of the lower part of the penetration hole 53 is, similar to the holding hole 31c and the like, slightly larger than the screw head 8 to be screwed. The upper part of the penetration hole 53 is formed in a tapered so as to gradually become narrower toward the lower side. The inner wall of the penetration hole 53 may be guided the drop path (supply path) of the screw 8.

To continue, an operation for supplying the screw 8 to the workpiece to be screwed 9 employing the screw supply jig 3 of the present embodiment will be briefly described.

In the screw supply jig 3, a required number of screws 8 are set in advance. This preparation work can be performed with a screw preparation device 6 or the like shown in FIG. 1, however, without being limited to this.

During the preparation work, an external force is not applied to the slide portion 4. Therefore, the slide portion 4 is at the base position as shown in FIG. 4. In that state, when the screw 8 is inserted into the holding hole 31c positioned with head up, the screw shaft 8 is inserted into the long hole part 43a, and then the screw head 8 is positioned in the holding hole 31c above the long hole part 43a. Each of the respective plurality of screws 8 is, in this state, held with the screw supply jig 3.

First, the case 90 is held with the adsorbing portion 21 of the first arm 12a (in other words, the first end effector 2a) and may be set at an appropriate position on a workbench 60 shown in FIG. 1. In addition, the electronic board 91 is held with the adsorbing portion 21 of the second arm 12b (in other words, the second end effector 2b) and may be set on a predetermined position of the case 90. By this assembly work, the workpiece to be screwed 9 is composed on the workbench 60.

To begin with, the operation of supplying screws 8 will be started. Specifically, the first arm 12a grips the screw supply jig 3 by using the first end effector 2a and moves the screw supply jig 3. In the above position where the screw tightening is required in the workpiece to be screwed 9, so that the holding hole 31c, the switching hole 43 and the chute portion 52 for accommodating the corresponding screws 8 are disposed, positioning of the screw supply jig 3 by the first arm 12a is performed (positioning process).

Subsequently, the second arm 12b with the second end effector 2b thereon moves. With this movement, the lever pressing portion 24 contacts the lever 42a, and the body portion 42 is pushed to be slidable moved in the direction of the white arrow of FIG. 4 (screw supplying process).

As this result, the switching hole 43 moves relatively to the holding hole 31c, and the round hole part 43b is located below the holding hole 31c. Hereinafter, as shown in FIG. 5, the position of the slide portion 4 when the round hole part 43b faces the holding hole 31c in the vertical direction may be referred to as the operating position. In a process that the slide portion 4 moves from the base position to the operating position, the screw head 8 is held by the holding hole 31c. Therefore, the shaft part of screw 8 moves relative to the switching hole 43 and exits from the long hole part 43a to the round hole part 43b.

When the round hole part 43b faces the holding hole 31c in the vertical direction, the screw 8 whose head is no longer supported fall down by its own weights, as shown in FIG. 5, and is passed through the round hole part 43b to reach a position in the penetration hole 53 of the screw guide portion 5. Although not shown, the tip portion of the screw 8 after reaching is in contact with the opening of the workpiece to be screwed 9. Because of the chute portion 52 is close to lower the workpiece to be screwed 9, most of the screw 8 are located inside the penetration hole 53 even after falling. Contacting the screw head 8 on the inner wall of the penetration hole 53, the screw 8 to be supported so as to prevent it from the falling. And thus, the posture of the screw 8 is in an upright attitude even after falling.

When a state where the lever pushing part 24 pushes the lever 42a so that the slide portion 4 is at the operating position, as shown in FIG. 5, the bit of the electric driver 23 is located directly above the holding hole 31c. Conversely, in the second end effector 2b, to provide such a positional relationship, the lever pressing portion 24 and the electric driver 23 are disposed, respectively.

The second arm 12b lowers the second end effector 2b from the state shown in FIG. 5. This enables, due to the electric driver 23 is moved to a lower position, the tip of the driver bit pass through the holding hole 31c and the round hole part 43b and meshes with the screw head 8 located in the penetration hole 53. In this state, the driver bit is lowered while rotated and then, the screw 8 can be tightened to the workpiece to be screwed 9. After the tightening is completed, the driver bit pull out from the screw supply jig 3 by moving above the electric driver 23, and further the pressing of the lever 42a is released by the lever pressing portion 24.

After that, the screw supply jig 3 is moved by the first arm 12a so that the holding hole 31c for accommodating the next screw 8, the switching hole 43, and the chute portion 52 are located directly above the next screw fastening position. And next, as mentioned above, the second arm 12b drops the screw 8 by sliding the slide portion 4 with the lever pressing portion 24, and screw fastening is performed by the electric driver 23. While repeating this operation, screw fastening can be performed by supplying screws 8 respectively to a plurality of positions on the workpiece to be screwed 9.

The screw supply jig 3 of the present embodiment can be held a plurality of screws 8. And thus, it is possible to reduce the frequency with which the first arm 12a changes the hold of the screw supply jig 3, and the working efficiency is improved.

In addition, the screw supply jig 3 itself has a simple configuration, it is possible to perform relatively easily a hole machining in the base portion 31 and the slide portion 4 for example. From this result, according to the outer diameter of the screw head 8, and the length and thickness of its shaft part or the like, it is possible to form easily different sizes of the holding hole 31c, the switching hole 43, and the screw guide portion 5. And thus, although even in the screw fastening is performed with the use of screws 8 of different sizes on the workpiece to be screwed 9, it is possible to perform with this easily and at low cost.

As described above, the screw supply jig 3 of the present embodiment is employed to supply screws to the workpiece to be screwed 9. The screw supply jig 3 includes a base portion 31 and a slide portion 4. The slide portion 4 is disposed lower the base portion 31. Either of the base portions 31 and the slide portion 4 can be slidably moved in a mutual relative to the other. In the base portion 31, the holding hole 31c penetrating the base portion 31 in the vertical direction is formed. In the slide portion 4, at least a part of a switching hole 43 penetrating through the second member is formed in the vertical direction. The switching hole 43 includes the long hole part 43a and the round hole part 43b having a width larger than that of the long hole part 43a in a plan view. The long hole part 43a and the round hole part 43b are disposed side by side in the direction of relative sliding of the base portion 31 and the slide portion 4 slide portion, and are connected to each other. In conjunction with the relative sliding of the base portion 31 and the slide portion 4, a situation in which the long hole part 43a of the switching hole 43 faces the holding hole 31c, and a situation in which the round hole part 43b faces the holding hole 31c are switched each other.

As a result, the screws 8 can be supplied to any position with a simple configuration.

In addition, in the screw supply jig 3 of the present embodiment, a plurality of holding holes 31c are formed in the base portion 31. The plurality of slide portions 4 are provided flexibly in various situations corresponding to each of the plurality of holding holes 31c.

Thereby, a plurality of screws 8 can be supplied with one screw supply jig 3. Thus, it is possible improve work efficiency to reduce the replacement frequency of the screw supply jig 3.

In addition, in the screw supply jig 3 of the present embodiment, each of the plurality of slide portions 4 is provided slidably relative to the base portion 31. Each of the plurality of slide portions 4 is slidable independently relative to the other slide portions 4.

This enables, the plurality of screws 8 set on the screw supply jig 3 may be supplied one by one at any timing by sliding the corresponding slide portion 4.

Moreover, in the screw supply jig 3 of the present embodiment, a plurality of switching holes 43 are provided. The plurality of switching holes 43 includes the switching holes 43 having round hole parts 43b with mutually different sizes.

This enables, with a simple configuration employing one screw supply jig 3, it is possible to supply a plurality of screws 8 with mutually different sizes.

The screw supply jig 3 of the present embodiment further includes a screw guide portion 5 which guides the supply path of the screw 8. The base portion 31, the slide portion 4, and the screw guide portion 5 are disposed in order from the top in the vertical direction.

Accordingly, the screw 8 can be accurately guided to a predetermined position.

Also, the dual-arm robot 1 of the present embodiment includes the first arm 12a and the second arm 12b. The first arm 12a holds the screw supply jig 3. The second arm 12b holds the electric driver 23.

As this result, it is possible to efficiently perform the screw 8 supplying and tightening in cooperation.

Although the preferred embodiment of the present invention has been described above, the above configuration can be modified, for example, as follows.

For example, the screw supply jig 3 may include a position holding mechanism composed of a ball plunger (not shown). This allows, the slide portion 4 can be certainly hold at either the base position or the operating position.

A single supply unit capable of supplying only one screw 8 can be configured such that only one holding hole 31c is formed and one slide portion 4 and one screw guide portion 5 are provided in a member to be base. A screw supply jig 3 capable of supplying a plurality of screws 8 can be configured by connecting a plurality of these single supply units. Thereby, it is possible to readily obtain the screw supply jig 3 suitable for the workpiece to be screwed 9, by selecting a single supply jig according to the type and number of screws of the workpiece to be screwed 9.

For each of the plurality of respective screws 8 held on the screw supply jig 3, for example, the size of head and the length of shaft are arbitrary. The head size of the multiple screws 8 may not be different size from each other, but all the head size of the multiple screws 8 may be the same size.

Instead of the long hole part 43a, the recessed part which does not penetrates the slide portion 4 in the vertical direction can be formed. This recessed part forms an opening on the upper face of the body portion 42 in the same manner, similarly to the long hole part 43a. Even with a non-penetrating recessed part, if the entire shaft part of the screw 8 is accommodated therein, the screw 8 can be supplied without any problem.

The above-described return mechanism may also be omitted. In this case, by the lever pressing portion 24 or the screw preparation device 6, the slide portion 4 can be returned to the base position of FIG. 4. In this configuration, it is preferable to provide the above-described position holding mechanism to prevent the position of the slide portion 4 from moving unexpectedly.

Although the holding hole 31c is circular, instead of this, for example, a polygonal hole may be formed. The round hole part 43b is also similar.

The member (second member) on which the switching hole 43 had been formed to be the fixed side, and the member (first member) on which the holding hole 31c is formed may be slid relative to the member on the fixed side. To explain an example of this configuration, the plurality of switching holes 43 are formed in the second member on the fixed side. The plurality of first members on the slide side are provided flexibly in various situations corresponding to each of the plurality of switching holes 43. The first member is pushed by the lever pushing portion 24 and is slidable independently of each other. This enables, the screws 8 may be supplied one by one at any timing. As described above, the relative sliding movement of the first member and the second member can be realized by sliding at least one of the two members.

The workpiece to be screwed 9 is not limited to the electric modules, and can be applied to any product that requires a work to be screwed.

A device except for the dual-arm robot 1 can also be used the screw supply jig 3. For example, a robot having one arm member grips the screw supply jig 3, and can comprise an arm member of another robot pushes the slide portion 4 for sliding.

### REFERENCE SIGNS LIST

3 screw supply jig
31 base portion (first member)
31c holding hole (first passage hole)
4 slide portion (second member)
43 switching hole (second passage hole)
43a long hole part (first recessed part)
43b round hole part (second recessed part)
9 workpiece to be screwed

1. A screw supply jig which supplies a screw to a workpiece to be screwed comprising:
a first member, and
a second member disposed lower the first member, wherein
either of the first member and the second member can be slidably moved in a mutual relative to the other,
in the first member, a first passage hole penetrating through the first member is formed in the vertical direction,
in the second member, at least a part of a second passage hole penetrating through the second member is formed in the vertical direction.
the second passage hole has a first recessed part and a second recessed part which is a penetration shape and having a width larger than the first recessed part in planar view,
the first recessed part and the second recessed part are disposed side by side in the direction of relative sliding of the first member and the second member, and are connected to each other, and
in conjunction with the relative sliding of the first member and the second member, a situation in which the first recessed part of the second passage hole faces the first passage hole, and a situation in which the second recessed part faces the first passage hole are switched each other.

2. The screw supply jig according to claim 1, wherein
the plurality of first holding holes are formed in the first member, and
the plurality of second members are provided flexibly in various situations corresponding to each of the plurality of first holding holes.

3. The screw supply jig according to claim 2, wherein
each of the plurality of second members are provided slidably relative to the first member, and
each of the plurality of second members are slidable independently relative to the other second member.

4. The screw supply jig according to claim 1, wherein
the plurality of holding second holes are formed in the second member, and
the plurality of first members are provided flexibly in various situations corresponding to each of the plurality of second holding holes.

5. The screw supply jig according to claim 4, wherein
each of the plurality of first members is provided slidably relative to the second member, and
each of the plurality of first members are slidable independently relative to the other first member.

6. The screw supply jig according to claim 1, wherein
the plurality of second holding holes are provided, and
the plurality of second holding holes includes a second holding hole having the second recessed part with mutually different sizes.

7. The screw supply jig according to claim 1, wherein
further includes a screw guide portion which guides a supply path of the screw, and
the first member, the second member, and the screw guide portion are disposed in order from the top in the vertical direction.

8. A dual-arm robot comprising:
a first arm which holds the screw supply jig according to claim 1, and
a second arm which holds a screw tightening tool.

9. A screw supply method which supplies a screw to a workpiece to be screwed comprising:
a positioning process; a first member and a second member disposed lower the first member,
either of the first member and the second member can be slidably moved in a mutual relative to the other, in the first member, a first passage hole penetrating through the first member is formed in the vertical direction, in the second member, at least a part of a second passage hole penetrating through the second member is formed in the vertical direction, the second passage hole having a first recessed part and the second recessed part, the second recessed part is a penetration shape, a screw supply jig having a width larger than the first recessed part in planar view is held by using a screw supply device in the state of the first recessed part faces the first passage hole, and a screw is disposed in the first recessed part and the first passage hole, the screw supply jig to move so that the screw may be located directly above the supply target position on the workpiece to be screwed; and
a screw supplying process; the screw is naturally dropped by relatively sliding the first member and the second member slide portion so that the second recessed part faces the first passage hole.
